(19) United States
(12) Patent Application Publication
(10) Pub. No.: US 2006/0087971 A1
(43) Pub. Date: Apr. 27, 2006

(54) Method for reserving of PT system

(75) Inventors: Young-Ae Kim, Gyeonggi-Do (KR); Sung-Mu Son, Bundang-Gu (KR); Kang-Suk Huh, Gyeonggi-Do (KR); Hee-Joung Lee, Bucheon (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/253,747

(22) Filed: Oct. 20, 2005

(30) Foreign Application Priority Data
Oct. 23, 2004 (KR) 10-2004-85141

(51) Int. Cl. H04L 12/26

(52) U.S. Cl. 370/232

(57) ABSTRACT

A method for providing a push-to (PT) service employing an invitation reservation mechanism is disclosed in which an invitation reservation function is set in a PT server so that, without an instruction of a PT client, the PT server can invite other PT clients who are available for session establishment. A method for reserving a PT service includes setting an invitation reservation function in a transmitting side PT server; requesting and receiving by the transmitting side PT server state information of PT clients who are targets for joining a session when operation conditions of the invitation reservation function are met; and transmitting by the transmitting side PT server an invite signal to the PT clients when the PT clients are in a state available for establishment of a session.

### BACKGROUND OF THE INVENTION

1. Field of the Invention

The present invention relates to a PT service and, more particularly, to a PT service employing a reservation mechanism.

2. Description of the Related Art

A PT service, which is intended to provide rapid communications for service providers and consumers of mobile network, is a communication service in which one client transmits media data (talk burst) to one or more other clients with which a session has been established. A PT service can be a push to talk (PTT) service for transmission of voice (audio) data, a push to view (PTV) service for transmission of moving picture (video) data, or a push to data (PTD) service for transmission of data. The PT service allows communication with a single recipient (1-to-1) or between groups of recipients as in a group chat session (1-to-many), and uses a session initiation protocol (SIP) to establish a session.

A PT client can communicate with a different PT client without having to perform a dialing process, a waiting process for call connection and a call connection tone providing process, so it can support a fast communications service compared with an ordinary mobile communication terminal.

In general, a PT system provides a PT service such that when a transmitting side PT client transmits an invite message to a user (or a plurality of users), a session is established between a receiving side PT client (or PT clients) accepting the invitation and the transmitting side PT client(s) and PT communications can be performed therebetween.

In such a PT system, when the transmitting side PT client transmits the invite message to the receiving side PT client, it does not know whether the receiving side PT client can be available for establishment of the session with the transmitting side PT client.

If the receiving side PT client has set an incoming session barring feature or has roamed to a network which cannot interwork with the network to which the transmitting side PT client belongs, the session cannot be established between the transmitting side PT client and the receiving side PT client.

Thus, when the receiving side PT client does not accept the invitation of the transmitting side PT client, because the transmitting side PT client does not now when the receiving side PT client can be changed to an invitation-acceptable state, the transmitting side PT client undesirably repeats its invite message transmissions until the receiving side PT client accepts the invitation. This is disadvantageous because it wastes resources, unnecessarily consumes battery power, and is inconvenient to the users.

### BRIEF DESCRIPTION OF THE INVENTION

Therefore, one object of the present invention is to provide a method for reserving a service of a PT system capable of inviting a receiving side PT client by setting a reservation function in a PT server and checking whether a transmitting side PT client and a receiving side PT client are in a state available for establishing a session when reservation conditions are met.

Another object of the present invention is to provide a method for reserving a service of a PT system capable of determining whether to invite by setting session establishment conditions of a PT client in a PT server and checking preference information as well as presence information of the PT client when invitation reservation conditions are met.

To achieve at least the above objects in whole or in parts, there is provided a method for reserving a PT service including: setting an invitation reservation function in a PT server; and inviting by the PT server one or more PT clients which are target for reservation when operation conditions of the invitation reservation function are met.

To achieve at least these advantages in whole or in parts, there is further provided a method for reserving a PT service including: setting an invitation reservation function in a transmitting side PT server; requesting and receiving by the transmitting side PT server state information of PT clients who are targets for joining a session when operation conditions of the invitation reservation function are met; and transmitting by the transmitting side PT server an invite signal to the PT clients when the PT clients are in a state available for establishment of a session.

To achieve at least these advantages in whole or in parts, there is further provided a method for reserving a PT service including: setting an invitation reservation function in a receiving side PT server; requesting and receiving by the receiving side PT server state information of PT clients who are targets for joining a session when operation conditions of the invitation reservation function are met; and transmitting by the receiving side PT server an invite signal to the PT clients when the PT clients are in a state available for establishment of a session.

To achieve at least these advantages in whole or in parts, there is further provided a method for reserving a PT service including: setting preference information of a transmitting side PT client in a transmitting side PT server; requesting and receiving, by the transmitting side PT client, a checking result of presence information and preference information of PT clients who are targets for joining a session; and transmitting by the transmitting side PT client an invite signal according to the checking result.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the construction of an exemplary PT system in accordance with the present invention;

FIG. 2 is a signal flow chart of an exemplary PT system in accordance with a first embodiment of the present invention;

FIG. 3 is a signal flow chart of an exemplary PT system in accordance with a second embodiment of the present invention;

FIG. 4 is a signal flow chart of an exemplary PT system in accordance with a third embodiment of the present invention; and

FIG. 5 is a signal flow chart of an exemplary PT system in accordance with a fourth embodiment of the present invention.

### DETAILED DESCRIPTION OF THE INVENTION

The present invention will now be described with reference to the accompanying drawings.

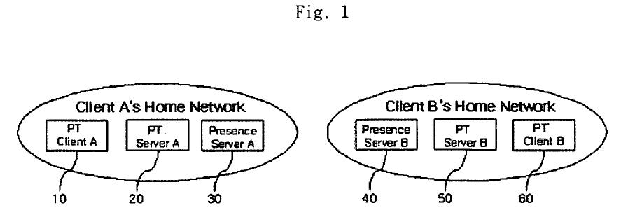

FIG. 1 illustrates the construction of an exemplary PT system in accordance with the present invention, in which a home network of a PT client ‘A’ and a home network of a PT client ‘B’ are different networks and have the same structure.

As shown in FIG. 1, home networks of the PT clients include PT clients 10 and 60 for providing a user interface for a PT service, PT servers 20 and 50 for processing a PT signal and media data, and presence servers 30 and 40 for providing presence information of the PT clients 10 and 60, respectively.

The PT clients 10 and 60 can set user preference information and reservation functions in the PT servers 20 and 50. The PT servers 20 and 50 check the preference information and presence information provided from the presence servers 30 and 40, and transmits/receives an invite message.

The home networks of the clients ‘A’ and ‘B’ support the presence server, and if the presence server is not supported, the PT servers 20 and 50 perform the function of the presence servers 30 and 40.

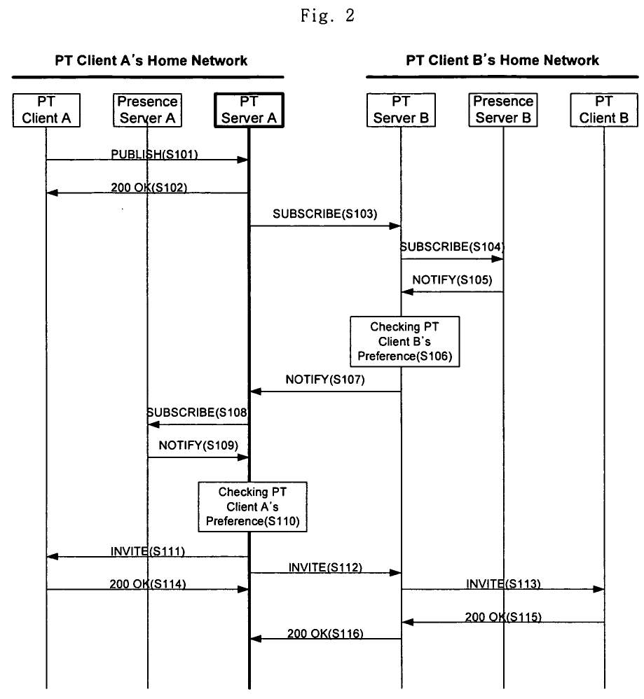

FIGS. 2 to 5 are signal flow charts of an exemplary PT system in accordance with the present invention.

As shown, a signal transmitted/received by the PT server or the PT client is routed by an SIP/IP core and transmitted to a different PT server or PT client. For the sake of explanation, the SIP/IP core is omitted.

FIG. 2 is a signal flow chart of the PT system in accordance with the first embodiment of the present invention, in which an invitation reservation function is set in the PT server ‘A’ and when reservation conditions are met, the PT server ‘A’ transmits an invite signal.

In order to set an invitation reservation function, the PT client ‘A’ transmits a publish signal to the PT server ‘A’ (step S101). In this case, the publish signal can include reservation information such as identification information of an invitee, a reservation function operation time, a reservation function termination time, or the like. The identification information of an invitee can be a TEL URI or an SIP URI of an invitation target client, or can be an ID of an invitation target group.

The PT server ‘A’ sets a reservation function according to the reservation information received through the publish signal and transmits a response signal (200 OK) with respect to the publish signal to the PT client ‘A’ (step S102). Herein, it is assumed that a reservation function having the PT clients ‘A’ and ‘B’ as invitation targets is set in the PT server ‘A’.

When reservation function operation conditions are met, the reservation function-set PT server ‘A’ transmits a subscribe signal to the PT server ‘B’ to request state information (presence information and preference information) of the PT client ‘B’, namely, an invitation target (step S103). The PT server ‘B’ transfers the subscribe signal to the presence server ‘B’ (step S104).

The presence server ‘B’ transmits a notify signal including online/offline state information of the PT client ‘B’ to the PT server ‘B’ (step S105). When the power of the PT client is turned off or when the PT client ‘B’ is logged out of a PT service program, information indicating that the PT client ‘B’ is in an offline state is included in the notify signal, and if the PT client ‘B’ is logged in to the PT service program, information indicating that the PT client ‘B’ is in a log-in state is included in the notify signal.

If the notify signal includes the information indicating that the PT client is in an online state, the PT server ‘B’ checks the preference information of the PT client ‘B’ (step S106). It is assumed that the preference information is previously stored in the PT server ‘B’ by the PT client ‘B’ or by an external interworking device.

For example, preference information of the PT client ‘B’ stored in the PT server ‘B’ can have the following items.

1) Access List

The access list can include information of a client or client group that allows establishment of a session. A user can register every client (e.g., access list=all), specific clients (access list=clients ‘A’ and ‘C’), or clients except for the specific clients (e.g., access list=all except for clients ‘A’ and ‘C’) in the access list.

2) Incoming Session Barring

The PT client may decline (not accept) an invitation by setting an incoming session barring feature (function) in the PT server. In this case, the PT client can set conditions under which an incoming session barring function can be operated to thereby restrict only an invitation with respect to a PT client satisfying conditions. For example, the incoming session barring function can be operated only for an invitation with respect to a PT client belonging to a network of a different country.

3) Session on Holding

The session on holding function allows determining of whether to terminate an existing PT session and set a new PT session or whether to maintain the existing session, when a new invitation message is received in a state that a session has been established with a different PT client.

4) Triggering Parameter

The triggering parameter provides a determining reference whether to attempt establishing of a session only when every invitation target (e.g., PT clients) is available for a session or whether to attempt establishing of a session when at least one invitation target (PT client) is available for a session.

5) Interworking Network Information

If an invited client belongs to a network which cannot interwork with a network to which an inviting client belongs, a PT service cannot be provided. Thus, whether a PT service is available for use or not is checked through the interworking network information.

Upon checking the preference information items, the PT server ‘B’ can transmit a notify signal including the checking result to the PT server ‘A’ (step S107). In this case, the PT server ‘B’ can inform only the session establishment available (or unavailable) state through the notify signal or can inform more detailed state information of the PT client ‘B’ according to each preference item.

For example, the notify signal can include information that the PT client ‘A’ is in the access list, the incoming session barring function has not been set, and the PT client ‘B’ has been established for a session with a different PT client and the session on holding function has been set. In addition, the notify signal can include only information that the PT client ‘B’ is simply in a state that it can accept an invitation.

If the PT server ‘A’ recognizes that the PT client ‘B’ is in a state that it can establish a session with the PT client ‘A’ through the notify signal, it transmits a subscribe signal to the presence server ‘A’ to check the state information of the PT client ‘A’ (step S108).

Upon receiving the subscribe signal, the presence server ‘A’ transmits a notify signal indicating online/offline state information (presence information) of the client ‘A’ to the PT server ‘A’ (step S109). In this case, if the client ‘A’ is logged in for a PT service program, information indicating the online state is included in the notify signal, while if power of the client ‘A’ is turned off or is logged out of the PT service program, information indicating an offline state is included in the notify signal.

If the PT server ‘A’ recognizes that the client ‘A’ is in the online state through the notify signal, it checks preference information of the PT client ‘A’ (step S110). The preference information can be stored in the PT server ‘A’ (step S101) or can be previously stored in the PT server ‘A’ by the PT client ‘A’ or a different external interworking device. The preference information can include an access list, outgoing session barring, session on holding, triggering parameter, and interworking network information.

Herein, when the outgoing session barring function is set, it is restricted for the PT client to invite other PT clients. In this case, when conditions under which the incoming session barring function is operated is also set, it is restricted to invite only PT clients satisfying the conditions.

If the PT client ‘A’ is in a state that it can invite the PT client ‘B’ according to the checking result of step S110, the PT server ‘A’ transmits an invite signal to the PT clients ‘A’ and ‘B’ to establish a session between the PT clients ‘A’ and ‘B’.

Subsequently, when the PT server ‘A’ receives a response signal (200 OK) with respect to each invite signal, a session is established between the PT clients ‘A’ and ‘B’ (steps S114-S116).

Herein, the invitation target is limited to the PT client ‘B’, but the reservation function can be set to invite a plurality of PT clients, and in this case, the PT server ‘A’ can establish a session in the same manner as in the steps S103 to S116 with respect to each PT client.

The above-described first embodiment describes the PT service providing process on the assumption that a session can be established between the PT clients ‘A’ and ‘B’.

The following second embodiment will describe a PT service providing process in case where the PT client ‘B’ cannot accept an invitation from the PT client ‘A’.

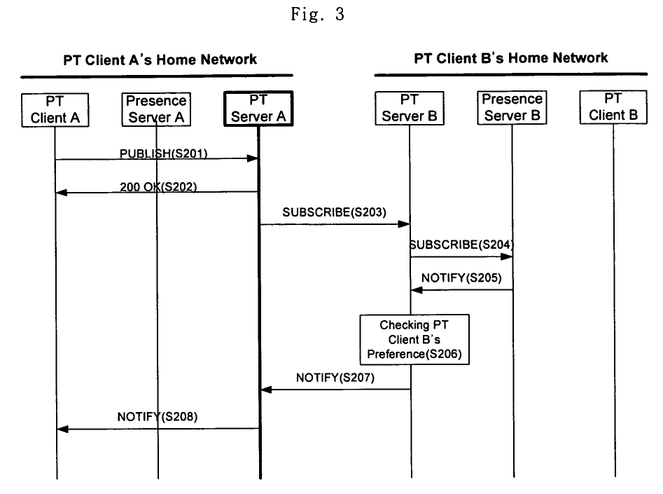

FIG. 3 is a signal flow chart of the PT system in accordance with the second embodiment of the present invention. A process from steps S201 to S205 is the same as that of the process from the steps S101 to S105 in the first embodiment of the present invention.

At the step S206, the PT server ‘B’ checks preference information of the PT client ‘B’ (step S206). In this case, it is assumed that the preference information has been previously set in the PT server ‘B’ by the PT client ‘B’ or an external interworking device. For example, items of the preference information of the PT client ‘B’ stored in the PT server ‘HB’ can be the same as those in the first embodiment. If the following state information is checked with respect to each item, the PT client ‘A’ cannot establish a session with the PT client ‘B’.

1) Access list: In case where a client ‘A’ is included in an access restriction target or in case where the client ‘A’ is not included in an access permission target.

2) Incoming session barring: In case where it is set to decline (not accept) an invitation with respect to every PT client, in case where it is set to decline (not accept) an invitation with respect to a network where the PT client ‘A’ belongs, or in case where it is set to decline (not accept) an invitation with respect to the PT client ‘A’.

3) Session on-holding: The PT client ‘B’ has been established for a session with a different PT client and set to maintain the existing PT session even if a new invitation message is received.

4) Triggering parameter: In case where a service is set to be used only when every invitation target is available for using the service and some PT clients of a plurality of invitation targets cannot use the service.

5) Interworking network information: In case where a network of the PT client ‘A’ corresponds to a network that does not interwork with the PT client ‘B’.

In the above-described cases, the PT server ‘B’ provides information that session establishment is not possible to the PT server ‘A’ and to the PT client ‘A’ through the notify signal (steps S207 and S208). In this case, the notify signal can include only the information that session establishment is not possible, or additionally include detailed state information of the PT client ‘B’ according to each preference information item.

However, if the PT server ‘B’ recognizes with the presence server ‘B’ that the PT client ‘B’ is in an offline state through the subscribe-notify steps S203 and S204, the step S206 is omitted and the PT server ‘B’ provides only information that session establishment is not possible to the PT server ‘A’ and the PT client ‘A’ through the notify signal.

Additionally, in case where a plurality of PT clients are invitation targets and a session is established only between some PT clients among them, if the PT client ‘B’ is changed to a state available for using the PT service before the session is released, the PT client ‘B’ can join the already established session.

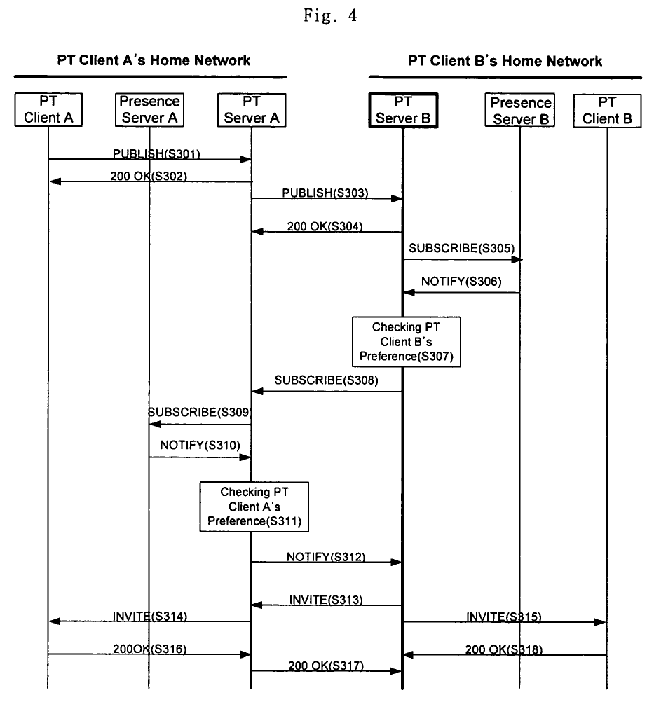

FIG. 4 is a signal flow chart of the PT system in accordance with a third embodiment of the present invention, in which an invitation reservation function is set in the PT server ‘B’, and when reservation conditions are met, the PT server ‘B’ transmits an invite signal.

In order to set the invitation reservation function in the PT server ‘B’, the PT client ‘A’ transmits a publish signal. The publish signal is transferred to the PT server ‘B’ after passing through the PT server ‘A’ and the PT servers ‘A’ and ‘B’ transmit a response signal (200 OK) with respect to the publish signal, respectively (steps S301 to S304).

The publish signal can include reservation information such as identification information with respect to an invitation target, a reservation function start time, a reservation function termination time, or the like. The identification information with respect to the invitation target can be TEL URI or SIP URI information of an invitation target client, or can be an ID of an invitation target group. Herein, it is assumed that a reservation function having the PT clients ‘A’ and ‘B’ as invitation targets has been set in the PT server ‘B’.

When the reservation function operation conditions set in the PT server ‘B’ are met, the PT server ‘B’ transmits a subscribe signal to the PT server ‘B’ to request state information of the PT client ‘B’, namely, the invitation target (step S305).

Upon receiving the subscriber signal, the presence server ‘B’ transmits a notify signal including online/offline state information of the PT client ‘B’ to the PT server ‘B’ (step S306). If power of the PT client ‘B’ is turned off or if the PT client ‘B’ has been logged out of the PT service program, information indicating that the PT client ‘B’ is in an offline state is included in the notify signal, while if the PT client ‘B’ has logged in for the PT service program, information indicating that the PT client ‘B’ is in a log-in state is included in the notify signal.

If the information indicating that the PT client ‘B’ is in the online state is included in the notify signal, the PT server ‘B’ performs the step of checking the preference information of the PT client ‘B’ (step S307).

The preference information of the PT client ‘B’ checked by the PT server ‘B’ can be the same as the preference information stored in the PT server ‘B’ in the first embodiment of the present invention. The preference information can be set by the PT client ‘B’ or by an interworking external device (e.g., a PC).

Upon checking, if the PT client ‘B’ is in a state that it can accept the invitation from the PT client ‘A’, the PT server ‘B’ transmits a subscribe signal to the PT server ‘A’ to check state information of the PT client ‘A’ (step S308).

The PT server ‘A’ receives online/offline state information of the PT client ‘A’ through the subscribe-notify steps with the presence server ‘A’ (steps S309 and S310).

When the PT server ‘A’ recognizes that the PT client is in the online state through the notify signal, the step of checking the preference information of the PT client ‘A’ (step S311) is performed. The preference information of the PT client ‘A’ checked by the PT server ‘A’ can be the same as the preference information stored in the PT server ‘A’ in the first embodiment. In one embodiment, the preference information can be included in the publish signal transmitted by the PT client ‘A’, and in another embodiment, the preference information can be set by a different interworking external device (e.g., a PC).

Subsequently, the PT server ‘A’ transmits a notify signal to the PT server ‘B’ in order to inform about a result of checking on the preference information of the PT client ‘A’ (step S312). In this case, the PT server ‘A’ can inform about only a session establishment available (or unavailable) state through the notify signal or can inform more detailed state information of the PT client ‘A’ according to each preference item.

Accordingly, the PT server ‘B’ can check the state information of the PT clients ‘A’ and ‘B’, and if a session can be established between the two clients, the PT server ‘B’ transmits an invite signal to the PT clients ‘A’ and ‘B’ (steps S313˜S315).

Upon receiving the invite signal, the PT clients ‘A’ and ‘B’ transmit a corresponding response signal (200 OK) to the PT server ‘A’, respectively, according to which a session is established between the two clients (steps S316˜S318).

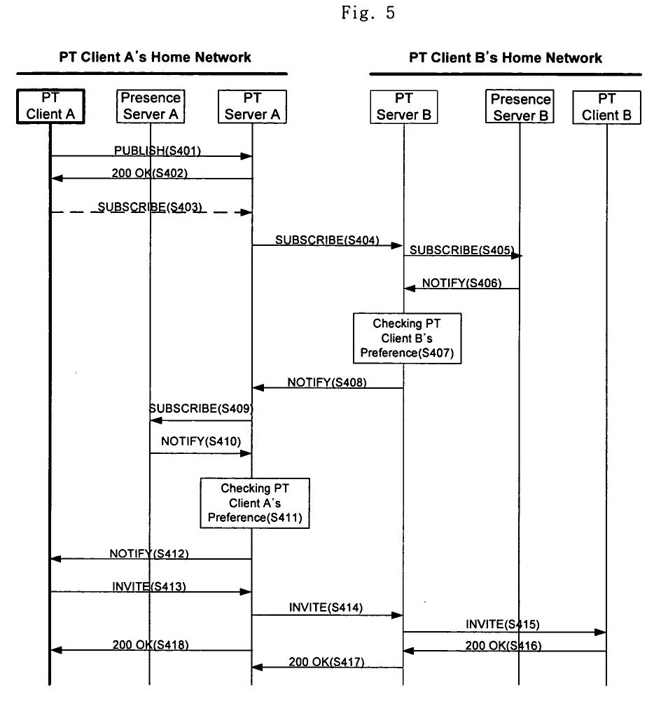

FIG. 5 is a signal flow chart of the PT system in accordance with a fourth embodiment of the present invention, illustrating a method for establishing a session according to a decision of the inviting PT client ‘A’ after checking state information of PT clients.

To begin with, the PT client ‘A’ transmits a publish signal to the PT server ‘A’ to set condition information (preference information) for a reservation function and session establishment (step S401). The preference information transferred through the publish signal can be the same as the preference information set in the PT server ‘A’ in the first embodiment of the present invention.

The PT server ‘A’ stores the reservation information for setting a reservation function and the preference information of the PT client ‘A’ which have been transferred through the publish signal, and transmits a response signal (200 OK) with respect to the publish signal to the PT client ‘A’ (step S402).

Thereafter, a series of process is performed to check state information of the PT clients ‘A’ and ‘B’ (steps S403˜S412).

First, when the PT client ‘A’ transmits a subscriber signal to the PT server ‘A’ to request state information of the PT client ‘B’, an invitation target (step S403), the PT server ‘A’ transfers the subscriber signal to the PT server ‘B’ (step S404).

The step S403 can be selectively performed, and although the PT server ‘A’ does not receive the subscriber signal in the step S403, when reservation function operation conditions are met, the step S404 can be performed. In this case, it is set in the PT server ‘A’ that the PT client ‘A’ is provided with state information of PT clients obtained through the subscribe signal in the step S404.

Upon receiving the subscribe signal, the PT server ‘B’ is provided with online/offline state information of the PT server ‘B’ through a subscribe-notify process with the presence server ‘B’ (steps S405 and S406).

When the PT server ‘B’ recognizes that the PT client ‘B’ is in an online state through the notify signal, it checks preference information of the PT client ‘B’ step S407). The preference information can be the same as the preference information set in the PT server ‘B’ in the first embodiment of the present invention. Namely, the preference information includes items for checking whether the client ‘B’ is on the access list or whether the incoming session barring function or the session on holding function has been set. In this case, the preference information can be set by the PT server ‘B’ by the PT client ‘B’ or an external interworking device.

The checking result obtained by the PT server ‘B’ is transferred to the PT server ‘A’ through a notify signal (step S408). If the notify signal includes information that the PT client ‘B’ can accept the invitation, the PT server ‘A’ checks online/offline state information of the PT client through a subscribe-notify process with the presence server ‘A’ (steps S409 and S410).

If the PT server recognizes through the notify signal that the PT client ‘A’ is in the online state, it checks the preference information of the PT client (step S411). The preference information can be the same as the preference information set in the PT server ‘A’ in the first embodiment of the present invention.

Subsequently, the PT server transmits the checking result to the PT client ‘A’ through a notify signal (step S412). In this case, the PT server ‘A’ can inform only a session establishment available state/session establishment unavailable state through the notify signal, or can inform more detailed state information of the PT client according to each preference item.

In addition, upon receiving the notify signal, the PT client ‘A’ can allow a user to recognize whether or not a session can be established in a visual or audible manner. For example, the PT client ‘A’ can display the fact that the PT client ‘A’ is in a state that it can establish a session with the PT client ‘B’ on a screen or output this information through audio speakers.

If the notify signal includes state information indicating that a session can be established, the PT client ‘A’ can transmit an invite signal to the PT client ‘B’ (steps S413˜S415) and receive a corresponding response (200 OK) signal to thus establish a session with the PT client ‘B’ (steps S416˜S418).

After the step S412 of receiving the notify signal by the PT client ‘A’, a user recognition step (not shown) can be additionally performed so that the steps S413 to S418 can be performed only when a user wants session establishment.

That is, when the PT client ‘A’ checks whether a session can be established or not through the notify signal, the PT client ‘A’ can establish a session by performing the steps S413˜S418 automatically or only when there is a positive response from the user.

For example, FIGS. 2 to 5 describe the PT system supported by the presence server, and in a PT system which is not supported by the presence server, the PT server can perform the above-described function of the presence server. According to an implementation method, the PT server can check a portion of the presence information provided by the presence server, or the presence server can provide a portion of preference information checked by the PT server.

In addition, the step of setting the preference information of the PT client in the PT server and the step of checking the preference information are selective, so these steps can be omitted.

The present invention provides an apparatus for a server supporting a push-to (PT) service in wireless communications, the apparatus comprising: a transceiver to send and receive signals between multiple mobile stations and multiple servers; a memory to store instructions related to push-to (PT) services; and a processor cooperating with the transceiver and the memory to perform the steps of, receiving, from a first mobile station of a first network, a publish signal containing conditions as to when a second mobile station of a second network may be invited to a session, monitoring the conditions until the second mobile station may be invited to the session, sending, in response to the monitoring, a subscribe signal to a presence server in the first network and a presence server in the second network, receiving, in response to the sending, a notify signal from the another server that checked preference information of either the second or the first mobile station, and checking preference information of the either the first or second mobile station, and inviting, in response to the checking, the second mobile station to the session being established with the first mobile station to allow a push-to (PT) service therebetween.

Here, if the notify signal indicated that the second mobile station is in an offline state, the subsequent steps for allowing the push-to (PT) service are not performed. If the preference information of at least one of the first mobile station and the second mobile station forbids the session to be established, then the inviting step is not performed. The server can be part of the first network and the another server is part of the second network. The server can be part of the second network and the another server is part of the first network.

Also, the present invention provides a mobile station supporting a push-to (PT) service in wireless communications, the mobile station comprising: a transceiver to send and receive signals between a server; a memory to store instructions related to push-to (PT) services; and a processor cooperating with the transceiver to perform the steps of, transmitting, to the server, a publish signal containing instructions to set an invitation containing conditions as to when another mobile station of another network may be invited to a session, and performing a push-to (PT) service with the another mobile station that was invited through the session established via the server when the conditions are satisfied.

Furthermore, the present invention provides a mobile station supporting a push-to (PT) service in wireless communications, the mobile station comprising: a transceiver to send and receive signals between a server; a memory to store instructions related to push-to (PT) services; and a processor cooperating with the transceiver to perform the steps of, receiving an invitation to a session from another mobile station in another network, after the another mobile station transmitted, to the server, a publish signal containing instructions to set an invitation containing conditions about being invited to a session, and performing a push-to (PT) service with the another mobile station that was invited through the session established via the server when the conditions are satisfied.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for reserving a push-to (PT) service comprising:
setting an invitation reservation function in a PT server; and
inviting by the PT server one or more PT clients which are target for reservation when operation conditions of the invitation reservation function are met.

2. The method of claim 1, wherein the invitation reservation function includes information regarding an invitation target and a reservation function operation time.

3. The method of claim 2, wherein the invitation reservation function additionally includes information regarding a reservation function termination time.

4. The method of claim 1, wherein, in the setting step, a serving PT client of the PT server sets the invitation reservation function.

5. The method of claim 1, wherein, in the setting step, an external device interworking with the PT server sets the invitation reservation function.

6. The method of claim 1, wherein the inviting step comprises:
checking, by the PT server, state information of PT clients who are targets for joining a session; and
if the state information of the PT clients satisfies the session establishment conditions, transmitting an invite signal for session establishment to the PT clients.

7. The method of claim 6, further comprising:
if only some of the PT clients satisfies the session establishment conditions, transmitting the invite signal only to the PT clients who satisfy the conditions.

8. The method of claim 7, further comprising:
if a PT client who has not satisfied the session establishment conditions is changed to a state of satisfying the session establishment conditions before the established session is not released, joining the session by the PT client.

9. The method of claim 6, wherein, in the step of transmitting the invite signal, a PT server which manages an inviting PT client transmits the invite signal.

10. The method of claim 6, wherein, in the step of transmitting the invite signal, a PT server which manages an invited PT client transmits the invite signal.

11. The method of claim 6, wherein the state information is stored in a PT server or in a presence server, and the session establishment conditions are stored in the PT server.

12. A method for reserving a push-to (PT) service comprising:
setting an invitation reservation function in a transmitting side PT server;
requesting and receiving, by the transmitting side PT server, state information of PT clients who are targets for joining a session when operation conditions of the invitation reservation function are met; and
transmitting, by the transmitting side PT server, an invite signal to the PT clients when the PT clients are in a state available for establishment of a session.

13. The method of claim 12, wherein the reservation function includes information regarding an invitation target and a reservation function operation time.

14. The method of claim 13, wherein the invitation reservation function additionally includes information regarding a reservation function termination time.

15. The method of claim 12, wherein, in the step of transmitting the invite signal, when the transmitting side PT client and one or more receiving side PT clients are available for session establishment, the invite signal is transmitted to the PT clients.

16. The method of claim 15, further comprising:
joining the established session by a PT client, if the PT client, among receiving side PT clients, is changed to a state of being available for session establishment from a session establishment unavailable state.

17. The method of claim 12, further comprising:
setting preference information, having conditions for session establishment of a transmitting side PT client, in a transmitting side PT server; and
setting preference information, having conditions for session establishment of a receiving side PT client, in a receiving side PT server.

18. The method of claim 17, wherein the preference information set in the transmitting side PT server includes at least one or more of information regarding an access list, outgoing session barring, session on holding, a triggering parameter and an interworking network.

19. The method of claim 17, wherein the preference information set in the receiving side PT server includes at least one or more of information regarding an access list, incoming session barring, session on holding, a triggering parameter and an interworking network.

20. The method of claim 17, further comprising:
requesting and receiving, by the transmitting side PT server, a result obtained by checking preference information of PT clients, targets for joining a session; and
transmitting an invite signal to PT clients that are available for session establishment only when the transmitting side PT client and at least one or more receiving side PT clients are available for session establishment according to the checking result.

21. The method of claim 17, further comprising:
requesting and receiving, by the transmitting side PT server, a result obtained by checking preference information of PT clients, targets for joining a session; and
transmitting an invite signal to PT clients when all the PT clients, who are targets for session establishment, are available for session establishment according to the checking result.

22. A method for reserving a push-to (PT) service comprising:
setting an invitation reservation function in a receiving side PT server;
requesting and receiving, by the receiving side PT server, state information of PT clients who are targets for joining a session when operation conditions of the invitation reservation function are met; and
transmitting, by the receiving side PT server, an invite signal to the PT clients to establish a session when the state information indicates that the PT clients are in a state available for session establishment.

23. The method of claim 22, wherein the reservation function includes information of an invitation target and information regarding reservation function operation conditions.

24. The method of claim 23, wherein the reservation function additionally includes information regarding reservation function termination conditions.

25. The method of claim 22, wherein, in the step of establishing a session, when a transmitting side PT client and one or more receiving side PT clients are in a state of being available for session establishment, an invite signal is transmitted only to the session establishment-available PT clients to establish a session.

26. The method of claim 25, further comprising:
joining the established session by a PT client, among the receiving side PT clients, which has been changed to a state of being available for session establishment from a session establishment unavailable state.

27. The method of claim 22, further comprising:
setting preference information having conditions for session establishment of a transmitting side PT client in a transmitting side PT server; and
setting preference information having conditions for session establishment of a receiving side PT client in the receiving side PT server.

28. The method of claim 27, wherein the preference information set in the transmitting side PT server includes at least one or more of information regarding an access list, outgoing session barring, session on holding, a triggering parameter and an interworking network.

29. The method of claim 27, wherein the preference information set in the receiving side PT server includes at least one or more of information regarding an access list, incoming session barring, session on holding, a triggering parameter and an interworking network.

30. The method of claim 27, further comprising:
requesting and receiving, by the receiving side PT server, a result obtained by checking preference information of PT clients, targets for joining a session; and
transmitting an invite signal to PT clients that are available for session establishment only when the transmitting side PT client and one or more receiving side PT clients are available for session establishment according to the checking result.

31. The method of claim 27, further comprising:
requesting and receiving, by the receiving side PT server, a result obtained by checking preference information of PT clients, targets for joining a session; and
transmitting an invite signal to PT clients when all the PT clients, who are targets for session establishment, are available for session establishment according to the checking result.

32. A method for reserving a push-to (PT) service comprising:
setting preference information of a PT client in a PT server;
requesting and receiving, by a transmitting side PT client, a checking result of presence information and preference information of PT clients who are targets for joining a session; and
transmitting, by the transmitting side PT client, an invite signal according to the checking result to establish a session according to the checking result.

33. The method of claim 32, further comprising:
notifying, by the transmitting side PT client, the presence information or the preference information through its output unit.

34. The method of claim 32, further comprising:
outputting, by the transmitting side PT client, a signal for checking whether or not to join a session.

35. The method of claim 34, further comprising:
not transmitting, by the transmitting side PT client, the invite signal regardless of the checking result of the presence information and the preference information, when the transmitting side PT client receives a response signal for rejecting session establishment.

36. The method of claim 32, wherein preference information set in the transmitting side PT server, among the preference information, includes at least one or more of information regarding an access list, outgoing session barring, session on holding, a triggering parameter and an interworking network.

37. The method of claim 32, wherein preference information set in the receiving side PT server, among the preference information, includes at least one or more of information regarding an access list, incoming session barring, session on holding, a triggering parameter and an interworking network.

38. The method of claim 32, wherein, in the step of establishing a session, when a checking result indicating that the transmitting side PT client and one or more receiving side PT clients are in a state of being available for session establishment, the invite signal is transmitted only to the session establishment-available PT clients to thus establish a session.

39. The method of claim 38, further comprising:
joining the established session by a PT client, among the receiving side PT clients, which has been changed to a state of being available for session establishment from a session establishment unavailable state.

40. An apparatus for a server supporting a push-to (PT) service in wireless communications, the apparatus comprising:
a transceiver to send and receive signals between multiple mobile stations and multiple servers;
a memory to store instructions related to push-to (PT) services; and
a processor cooperating with the transceiver and the memory to perform the steps of,
receiving, from a first mobile station of a first network, a publish signal containing conditions as to when a second mobile station of a second network may be invited to a session,
monitoring the conditions until the second mobile station may be invited to the session,
sending, in response to the monitoring, a subscribe signal to a presence server in the first network and a presence server in the second network,
receiving, in response to the sending, a notify signal from the another server that checked preference information of either the second or the first mobile station, and checking preference information of the either the first or second mobile station, and
inviting, in response to the checking, the second mobile station to the session being established with the first mobile station to allow a push-to (PT) service therebetween.

41. The apparatus of claim 40, wherein if the notify signal indicated that the second mobile station is in an offline state, the subsequent steps for allowing the push-to (PT) service are not performed.

42. The apparatus of claim 40, wherein if the preference information of at least one of the first mobile station and the second mobile station forbids the session to be established, then the inviting step is not performed.

43. The apparatus of claim 40, wherein the server is part of the first network and the another server is part of the second network.

44. The apparatus of claim 40, wherein the server is part of the second network and the another server is part of the first network.

45. A mobile station supporting a push-to (PT) service in wireless communications, the mobile station comprising:
a transceiver to send and receive signals between a server;
a memory to store instructions related to push-to (PT) services; and
a processor cooperating with the transceiver to perform the steps of,
transmitting, to the server, a publish signal containing instructions to set an invitation containing conditions as to when another mobile station of another network may be invited to a session, and
performing a push-to (PT) service with the another mobile station that was invited through the session established via the server when the conditions are satisfied.

46. A mobile station supporting a push-to (PT) service in wireless communications, the mobile station comprising:
a transceiver to send and receive signals between a server;
a memory to store instructions related to push-to (PT) services; and
a processor cooperating with the transceiver to perform the steps of,
receiving an invitation to a session from another mobile station in another network, after the another mobile station transmitted, to the server, a publish signal containing instructions to set an invitation containing conditions about being invited to a session, and
performing a push-to (PT) service with the another mobile station through the session established via the server when the conditions are satisfied.
